(19) United States
(12) Patent Application Publication
(10) Pub. No.: US 2014/0251114 A1
(43) Pub. Date: Sep. 11, 2014

(54) KEYBOARD SYSTEM WITH MULTIPLE CAMERAS

(71) Applicant: Yoshinari Yoshikawa, Los Altos, CA (US)

(72) Inventor: Yoshinari Yoshikawa, Los Altos, CA (US)

(73) Assignee: Miselu, Inc., San Francisco, CA (US)

(21) Appl. No.: 13/842,753

(22) Filed: Mar. 15, 2013

Related U.S. Application Data
(63) Continuation-in-part of application No. 13/791,335, filed on Mar. 8, 2013.

(51) Int. Cl. G09B 15/00

(52) U.S. Cl. CPC G09B 15/00
USPC 84/478

(57) ABSTRACT

Embodiments generally relate to providing a keyboard system. In one embodiment, a keyboard system comprises a keyboard apparatus including a piano-style keyboard, a display screen operably connected to the keyboard apparatus; and first and second cameras attached to the display screen. The first camera is positioned to capture light from a first field to produce a first set of image data and the second camera is positioned to capture light from a second field, different from the first field, to produce a second set of image data

### CROSS REFERENCES TO RELATED APPLICATIONS

This application is a continuation-in-part of U.S. patent application Ser. No. 13/791,335, entitled “Portable Piano Keyboard Computer”, filed on Mar. 8, 2013 which is hereby incorporated by reference as if set forth in full in this application for all purposes.

### BACKGROUND

Compact electronic musical devices including piano-type keyboards are increasingly available, for recreational, educational, and professional use. This application extends the capabilities of such devices by adding the ability to capture images of the keyboard and/or images of parts of the user's body during keyboard operation, and to present the images or data derived at least in part from those images to the user or users. This application is related in general to a computer system that includes two or more cameras attached to a display screen that is in turn connected to a keyboard apparatus. Image data captured by the cameras observing different fields of view may be processed to provide image data, which in turn may be displayed or used to adjust operating parameters of the keyboard apparatus.

### SUMMARY

Embodiments generally relate to providing a keyboard system. In one embodiment, a keyboard system comprises a keyboard apparatus including a piano-style keyboard, a display screen operably connected to the keyboard apparatus; and first and second cameras attached to the display screen. The first camera is positioned to capture light from a first field to produce a first set of image data and the second camera is positioned to capture light from a second field, different from the first field, to produce a second set of image data

In another embodiment, a method for providing an interactive keyboard operating experience comprises first providing a keyboard system comprising a keyboard apparatus including a piano-style keyboard, a display screen operably connected to the keyboard apparatus, and first and second cameras attached to the display screen; wherein the first camera is positioned to capture light from a first field to produce a first set of image data and the second camera is positioned to capture light from a second field, different from the first field, to produce a second set of image data; and then positioning the display screen such that the first set of image data captured by the first camera comprises a view of at least one part of the body of a user operating the keyboard apparatus.

### BRIEF DESCRIPTION OF THE DRAWINGS

FIG. 1 is a schematic view of an example keyboard system configured to allow two cameras to capture two separate sets of image data, according to some embodiments.

FIG. 2 illustrates an example keyboard system configured to allow one camera to view the keyboard and another camera to view the face of the user, according to some embodiments.

FIG. 3 illustrates an example keyboard system configured to allow one camera to view the torso of the user and another camera to view space into which the user may reach, according to some embodiments

FIG. 4 illustrates an example keyboard system configured to show a captured and processed image of the keyboard being played, according to some embodiments.

### DETAILED DESCRIPTION

Embodiments described herein enable the user of a keyboard to enjoy an interactive playing experience, enhanced by the use of image data captured by cameras attached to a display screen facing the user. Each camera captures light from a different object space, typically by being positioned at a correspondingly different tilt angle with respect to the planar front surface of the display screen.

Some embodiments provide a keyboard system that enables the user to view an image on the display screen of the keyboard being played. Some embodiments provide a keyboard system that sets an operating parameter of the keyboard apparatus, such as sound volume or persistence, according to a result derived by processing captured image data.

Some embodiments provide a keyboard system that provides information reflective of the keyboard playing performance of the user to that user or others by analyzing captured image data.

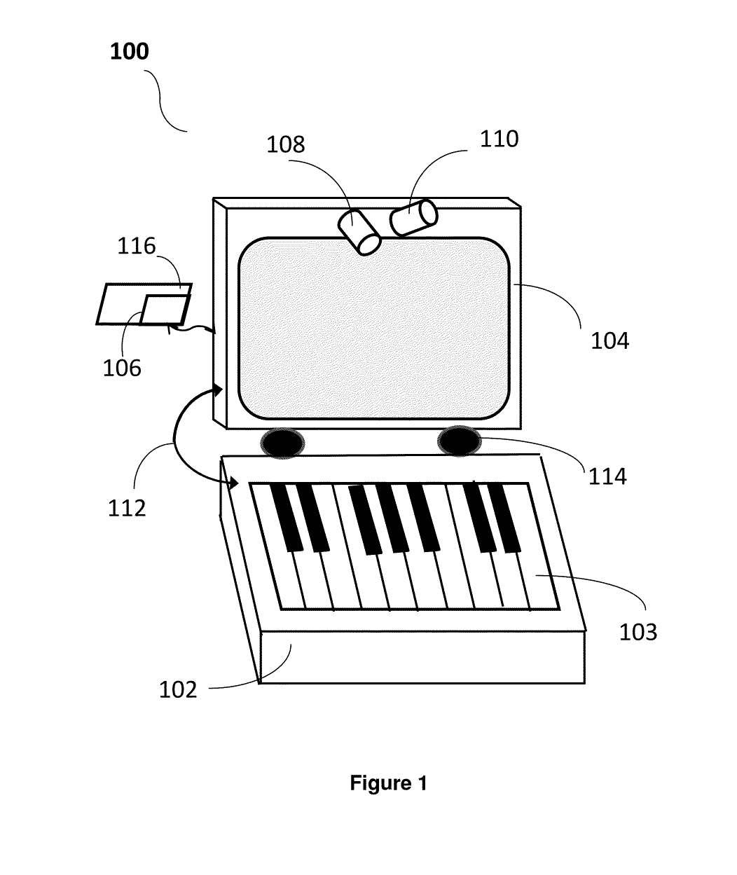

Various embodiments described below with particular reference to FIG. 1 through FIG. 5 allow such keyboard systems and methods of providing such systems to be realized.

FIG. 1 is a schematic view of an example keyboard system 100 including keyboard apparatus 102, a display screen 104 operably connected to the keyboard apparatus 102, to a digital processor 106, and to cameras 108 and 110 attached to the display screen. Keyboard apparatus 102 includes a piano-style keyboard 103. Camera 108 is positioned at a downwards tilt to capture light from the region of space at and immediately above the top surface of keyboard apparatus 102. This space may include the area of the keyboard over which either hand of a user (not shown in this figure for simplicity) may be positioned to strike the keys of the keyboard. Camera 110 is positioned at a different tilt angle to capture light from a different region. In the case shown, the region observed by camera 110 includes the space in which a user (not shown) might raise a right hand in some meaningful gesture.

It should be understood that the dimensions of cameras 108 and 110 are shown schematically in FIG. 1 with considerable exaggeration, for clarity. In practical embodiments, the cameras are likely to be extremely small, unobtrusive visually, and possibly embedded to lie beneath or almost flush with the front-facing surface of display screen 104. In all cases, as the tilt angle of display screen 104 with respect to the keyboard surface plane is changed, the particular regions of space observed by cameras 108 and 110 will change too.

Digital processor 106 may be included in keyboard apparatus 102, or in a computing unit 114 as shown, directly or indirectly connected to display screen 104, as indicated schematically in the figure. Alternately, digital processor 106 may be distributed in various ways between some or all of these elements. Digital processor 106 controls cameras 108 and 110, receiving image data and processing it in any of a variety of ways as will be discussed below. Keyboard apparatus 102 may be communicatively connected to display screen 104 in a variety of well-known ways, for example using plug in contacts, or wired, or wireless connections, indicated generically by element 112 in the figure. Keyboard apparatus 102 may be structurally connected to the display screen 104 in a variety of well-known ways, for example using hinges 114. Alternately, display screen 104 may be housed in a separate element such as a table computer which may be placed in a holder (not shown) attached to the top surface of keyboard apparatus 102, that holder allowing the tilt angle between screen 104 and keyboard apparatus 102 to be varied.

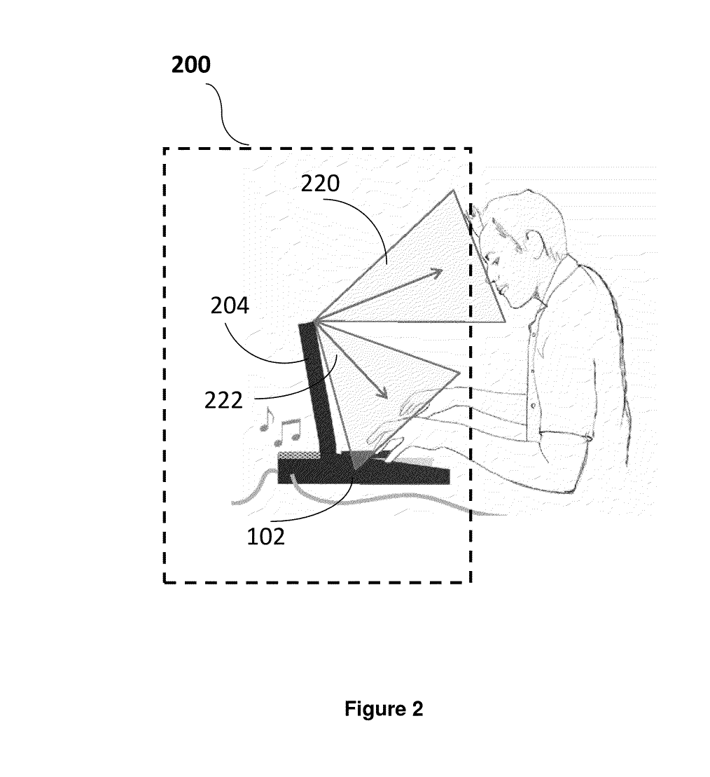

FIG. 2 illustrates an example keyboard system 200 according to some embodiments. Digital processor 112 and details of the keyboard apparatus 102 are omitted from this figure, for simplicity. The downward tilted camera is not explicitly shown, but indicated by its field of view 222. Similarly, the slightly upward tilted camera is not explicitly shown, but indicated by its corresponding field of view 220. Field 222 clearly includes the positions of the fingers of the user over the keyboard. In some embodiments, the image data gathered from this field is used to form an image that is then displayed on display screen 204. In some embodiments, that image is displayed on another display screen to be viewed remotely. In some embodiments, information derived from image data gathered from such a field is analyzed to yield information reflective of the keyboard playing performance of the user.

In some embodiments field 220 includes the face of the user. When system 200 is used in a training or tutorial mode, analysis of the image data collected from this field may allow involuntary movements or facial expressions to be detected and communicated back to the user via the display screen 204, thus performing an instructive function. When system 200 is used in a control or performance mode, analysis of the image data collected from this field may allow deliberate head movements or facial expressions to be detected and used to control specific parameters of the keyboard apparatus. A deliberate glance to the upper right, for example, may indicate the user's desire for a significant rise in volume.

Training and performance modes may function separately or in combination.

Furthermore, in those embodiments where field 220 is positioned to capture a view of the user's affect, defined herein to mean one or more observable manifestations of the user's subjectively experienced emotion, analysis of the image data may be used to set or modify one or more music variable such as mood, tempo, volume, or dynamical aspects of volume. For example, if image analysis of the captured image detects a wrinkled brow ridge, the digital processor may cause subsequent notes to be played staccato.

Table 1 below lists some of the traditional musical moods that may be “mapped” by the keyboard system's digital processor 106 to particular features of the user's affect. Table 2 below lists some of the traditional musical tempos, and Table 3 lists some of the traditional musical volume or related variables, defined herein as dynamical variables, that may similarly be mapped to other features of the user's affect.

TABLE 1
Mood

| | | |
|---|---|---|
| Affettuoso | with feeling | Tenderly |
| Agitato | agitated | Excited and fast |
| Animato | animated | Animated |
| Brillante | brilliant | Brilliant, bright |
| Bruscamente | brusquely | Brusquely - abruptly |
| Cantabile | singable | In a singing style |
| Comodo | convenient | Comfortably, moderately |
| Con amore | with love | with love |
| Con fuoco | with fire | with fiery manner |
| Con brio | with bright | with bright |
| Con moto | with movement | with (audible) movement |
| Con spirito | with spirit | with spirit |
| Dolce | sweetly | Sweet |
| Espressivo | expressive | Expressively |
| Furioso | furious | with passion |
| Grazioso | graciously or gracefully | with charm |
| Lacrimoso | teary | Tearfully, sadly |
| Maestoso | majestic | Stately |
| Misterioso | mysterious | Mysteriously, secretively, |
| | | enigmatic |
| Scherzando | playfully | Playfully |
| Sotto | subdued | Subdued |
| Semplicemente | simply | Simply |
| slancio | passion | enthusiasm |
| Vivace | vivacious | up-tempo |

TABLE 2
Tempo

| | | |
|---|---|---|
| Tempo | time | The speed of music ex. 120BPM |
| Largo | broad | Slow and dignified |
| Larghetto | a little bit broad | Not as slow as largo |
| Lentando | slowing | Becoming slower |
| Lento | slow | Slow |
| Adagio | ad agio, at ease | Slow, but not as slow as largo |
| Adagietto | little adagio | Faster than adagio; or a short adagio composition |
| Andante | walking | Moderately slow, flowing along |
| Moderato | moderately | At a moderate speed |
| Allegretto | a little bit joyful | Slightly slower than allegro |
| Largamente | broadly | Slow and dignified |
| Mosso | moved | Agitated |
| Allegro | joyful; lively and fast | Moderately fast |
| Fermata | stopped | Marks a note to be held or sustained |
| Presto | ready | Very fast |
| Prestissimo | very ready | Very very fast, as fast as possible |
| Accelerando | accelerating | Accelerating |
| Affrettando | becoming hurried | Accelerating |
| Allargando | slowing and | Slowing down and broadening, becoming more |
| | broadening | stately and majestic, possibly louder |
| Ritardando | slowing | Decelerating |
| Rallentando | becoming | Decelerating |
| | progressively slower | |
| Rubato | robbed | Free flowing and exempt from steady rhythm |
| Tenuto | sustained | Holding or sustaining a single note |
| Accompagnato | accompanied | The accompaniment must follow the singer who can |
| | | speed up or slow down at will |
| Alla marcia | as a march | In strict tempo at a marching pace (e.g. 120 bpm) |
| A tempo | to time | Return to previous tempo |
| L'istesso | Same speed | At the same speed |
| tempo | | |

TABLE 3
Volume/Dynamics

| | | |
|---|---|---|
| Calando | quietening | Becoming softer and slower |
| Crescendo | growing | Becoming louder |
| Decrescendo | shrinking | Becoming softer |
| Diminuendo | dwindling | Becoming softer |
| Forte | strong | Loud |
| Fortissimo | very strong | Very loud |
| Mezzo forte | half-strong | Moderately loud |
| Piano | gentle | Soft |
| Pianissimo | very gentle | Very soft |
| Mezzo piano | half-gentle | Moderately soft |
| Sforzando | strained | Sharply accented |

In some embodiments, a tilt of the head to the left may indicate the user's desire for a particular image to be displayed on display screen 222. In some embodiments, that image may include a written musical score. In some embodiments a particular gesture may be indicative of the user's wish to have a prerecorded musical track to be played to accompany the live music. Digital processor 106 may respond to these expressed desires by controlling the operation of the keyboard system accordingly.

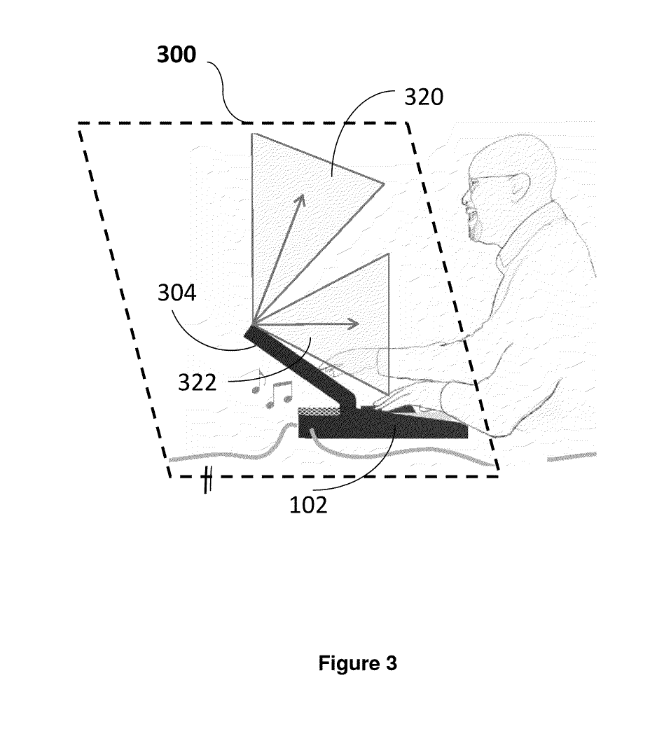

FIG. 3 illustrates an example keyboard system 300 according to some embodiments. As in FIG. 2, some elements, including digital processor 112, and details of the keyboard apparatus 102 are omitted from this figure, for simplicity. The downward tilted camera is not explicitly shown, but indicated by its field of view 322. Similarly, the slightly upward tilted camera is not explicitly shown, but indicated by its corresponding field of view 320. Display screen 304 is tilted back with respect to keyboard apparatus 102 to present a shallower orientation than that shown in FIG. 2. In this case, field 322 does not include the keyboard top surface, but includes the region of space in which the user's right hand is situated, while raised from the keyboard to touch elements on display screen 304. These elements, not shown, may include soft keys, slider mechanisms, knob controls, or even a virtual keyboard. In some embodiments, information derived from image data gathered from field 322 may be analyzed to yield information reflective of the actions of the user's hand on the display screen. In some embodiments, such yielded information may be used to control the operation of the keyboard system accordingly.

In some embodiments field 320 includes a region above and in front of the user, a region which the user could choose to access by raising an arm, for example, or by standing up (assuming an initial seated position) and leaning forward. Such deliberate gestures may be understood by a predetermined policy to indicate the user's desire to control corresponding characteristics of the operation of the keyboard apparatus as discussed above in paragraph [017].

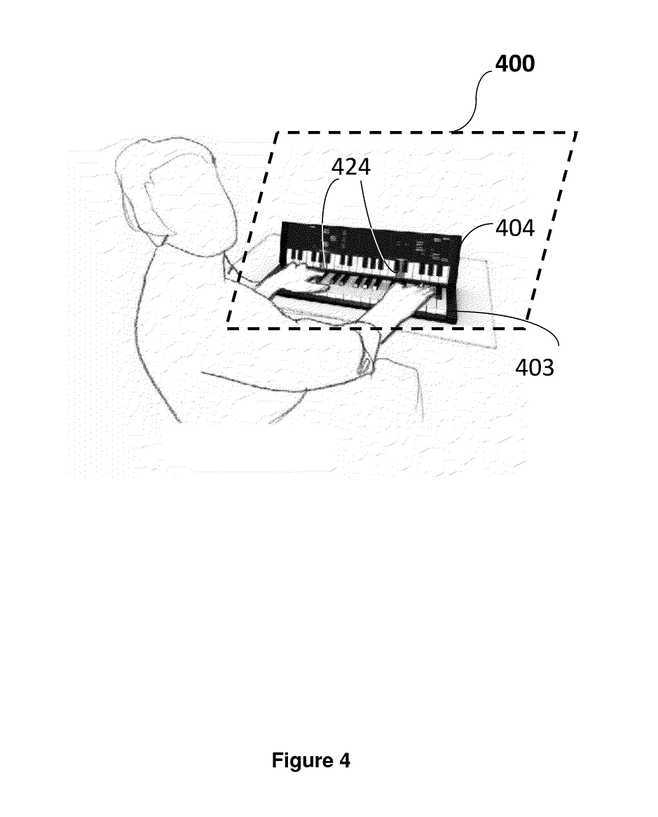

FIG. 4 illustrates an example keyboard system 400 showing display screen 404, displaying an image of keyboard 403 captured using a downward tilted camera (not shown). The keyboard image may be a “mirror” image, in the sense that the keyboard surface appears to be “reflected” by an imagined boundary between that keyboard and the display screen, but absent the lateral inversion that would occur with an actual mirror. In some embodiments, the keyboard image may be processed to substitute simple visual indications 424 at the keys that the user's fingers are pressing for images of the fingers themselves.

In some embodiments, the keyboard image displayed on display screen 404 may be a “mapped” image, derived from an image obtained from a camera viewing another keyboard apparatus (not shown) in system 400.

In some embodiments the keyboard apparatus may include a qwerty-type keyboard.

Embodiments described herein provide various benefits. In particular, embodiments enable a keyboard user to enjoy an interactive playing experience that may include training, instruction, real-time feedback on user performance, and/or control of user performance parameters.

Although the description has been described with respect to particular embodiments thereof, these particular embodiments are merely illustrative, and not restrictive. Any suitable programming language can be used to implement the routines of particular embodiments including C, C++, Java, assembly language, etc. Different programming techniques can be employed such as procedural or object oriented. The routines can execute on a single processing device or multiple processors.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms. In general, the functions of particular embodiments can be achieved by any means known in the art. Distributed, networked systems, components, and/or circuits can be used. Communication or transfer of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

A “processor” includes any suitable hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems. A computer may be any processor in communication with a memory. The memory may be any suitable processor-readable storage medium, such as random-access memory (RAM), read-only memory (ROM), magnetic or optical disk, or other tangible media suitable for storing instructions for execution by the processor.

As used in the description herein and throughout the claims that follow, “a”, “an”, and “the” includes plural references unless the context clearly dictates otherwise. Also, as used in the description herein and throughout the claims that follow, the meaning of “in” includes “in”, “on”, and “in close proximity to” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A keyboard system comprising:
a keyboard apparatus;
a display screen operably connected to the keyboard apparatus and a digital processor; and
first and second cameras attached and operably connected to the display screen;
wherein the first camera is positioned to capture light from a first field to produce a first set of image data and the second camera is positioned to capture light from a second field, different from the first field, to produce a second set of image data.

2. The keyboard system of claim 1, wherein at least one of the first and second sets of image data is displayed as an image on the display screen.

3. The keyboard system of claim 1, wherein at least one of the first and second sets of image data is processed to set an operating parameter of the keyboard apparatus.

4. The keyboard system of claim 3, wherein the operating parameter is a sound effect for a keystroke on the keyboard apparatus.

5. The keyboard system of claim 1, wherein at least one of the first and second sets of image data is displayed as an image on a display screen remote from the display screen connected to the first and second cameras.

6. The keyboard system of claim 1, wherein at least one of the first and second sets of image data is processed to set an operating parameter of a keyboard apparatus remote from the display screen connected to the first and second cameras.

7. The keyboard system of claim 1, wherein at least one of the first and second sets of image data is analyzed to yield information reflective of the performance of a user of the keyboard apparatus.

8. The keyboard system of claim 7, wherein at least a portion of the yielded information is displayed on the display screen.

9. The keyboard system of claim 8, wherein the displayed information comprises musical notation including indications of any corresponding keystroke errors made by the user.

10. The keyboard system of claim 1, wherein an angular adjustment of the display screen relative to the keyboard apparatus determines the first and second fields viewed by the first and second cameras.

11. The keyboard system of claim 7, wherein the keyboard apparatus includes at least one of a qwerty-type keyboard and a piano-style keyboard.

12. The keyboard system of claim 1, wherein the display screen is the display screen of a tablet computer.

13. A method for providing an interactive keyboard operating experience, the method comprising:
providing a keyboard system comprising:
a keyboard apparatus including a piano-style keyboard;
a display screen operably connected to the keyboard apparatus and a digital processor; and
first and second cameras attached to and operably connected to the display screen; wherein the first camera is positioned to capture light from a first field to produce a first set of image data and the second camera is positioned to capture light from a second field, different from the first field, to produce a second set of image data;
positioning the display screen such that at least one of the first and second cameras is positioned to capture image data including a view of at least one part of the body of a user operating the keyboard apparatus; and
processing, using the digital processor, the first and second sets of image data.

14. The method of claim 13, wherein a result of processing at least one of the first and second sets of image data is displayed as an image on the display screen.

15. The method of claim 13, wherein a result of processing at least one of the first and second sets of image data yields information reflective of the performance of the user.

16. The method of claim 16, wherein at least a portion of the yielded information is displayed on the display screen.

17. The method of claim 16, wherein the displayed information comprises musical notation including indications of any corresponding keystroke errors made by the user.

18. The method of claim 13 wherein positioning the display screen comprises positioning the display screen such that at least one of the first and second sets of image date captures information on the affect of the user; and wherein a result of processing the corresponding image data is used to set a mood of music played on the keyboard apparatus by the user.

19. The method of claim 13 wherein positioning the display screen comprises positioning the display screen such that at least one of the first and second sets of image date captures information on the affect of the user; and wherein a result of processing the corresponding image data is used to set a tempo of music played on the keyboard apparatus by the user.

20. The method of claim 13 wherein positioning the display screen comprises positioning the display screen such that at least one of the first and second sets of image date captures information on the affect of the user; and wherein a result of processing the corresponding image data is used to set a volume or dynamical variable of music played on the keyboard apparatus by the user.
